(19) United States
(12) Patent Application Publication
(10) Pub. No.: US 2012/0323989 A1
(43) Pub. Date: Dec. 20, 2012

(54) DYNAMIC DISTRIBUTION OF TARGET SELECTION ALGORITHMS

(75) Inventors: Jon MALOY, Montreal (CA); Per ANDERSSON, Montreal (CA)

(73) Assignee: TELEFONAKTIEBOLAGET L M ERICSSON (PUBL), Stockholm (SE)

(21) Appl. No.: 13/070,013

(22) Filed: Mar. 23, 2011

(51) Int. Cl. G06F 15/16

(52) U.S. Cl. 709/203

(57) ABSTRACT

Methods of distributing a selection algorithm that selects a target server component from among a plurality of server components having a same functionality type include receiving notifications from the plurality of server components indicating addresses at which the plurality of server components can be contacted, receiving a selection algorithm that is to be used by a client component for selecting the target server component from among the plurality of server components, and associating the selection algorithm with the functionality type. The methods may further include receiving a message from the client component requesting addresses of server components having the functionality type, sending the addresses of the plurality of server components to the client component, and sending the selection algorithm to the client component.

### TECHNICAL FIELD

The present invention relates to client/server based computing models, and more particularly to management of target selection algorithms in client/server based computing models.

### BACKGROUND

Many software applications are physically or logically split into separate components, or services, which communicate with each other via a communication mechanism. For example, some components/services of a software application may act as server components that provide defined services to other software components. Software components that utilize the services of other software components may be referred to as client components. Client components may be referred to as client/sender components, while server components may be referred to as server/receiver components, because client components typically send requests to server components, which process the requests.

Moreover, many software components are designed so that different instances of the component may be instantiated and operate concurrently at any given time. Different instances of a process can be instantiated on the same or different virtual machines operating on the same physical server and/or on different physical servers. Different instances of a process may be instantiated, for example, to provide load balancing, to dynamically provide additional processing capacity, to provide redundancy, and/or for many other reasons.

In order to send a message via an inter-component communication mechanism, the sending component must be able to identify a target server/receiver component and determine its address. For example, in situations where multiple instances of a service are available to a client/sender component, an address of a target server/receiver may be determined from among the available services using a selection algorithm. Such algorithms are often application specific, and may be different from the address lookup scheme provided by the communication service in question.

Designing a selection algorithm for server/receiver components is not a trivial task, because the system designer typically wants to build some desirable properties into the algorithm to fit the needs of the application in question. Such algorithms are typically tailor-made for a particular component or application.

A selection algorithm may have different features. For example, a selection algorithm may use various form of input data for selecting the destination server/receiver. The input data can include any data, such as a phone number, a uniform resource indicator (URI) or other form of string, a dimensionless number, or any other relevant data.

The output of the selection algorithm may be an address or other designation by which the client/sender component can communicate with the destination server/receiver component, such as an IP address, a DNS string, a Unix Socket identifier, a physical or logical memory address, a port number, etc.

The selection algorithm itself may take one of many different forms. For example, a selection algorithm can include a state-free hash algorithm, a parameterized hash algorithm, a translation by consulting some external source, etc. The selection algorithm may also include a scheme for how to use the translated address result when sending a message over the transport service. For example, the selection algorithm may designate that messages are to be sent according to a round-robin schedule, via multicast to different server components, by selecting between active and standby server/receiver components, by choosing at random, based on current load, etc.

Moreover, the selection algorithm for a particular service or type of service may need to be changed or upgraded during the lifetime of an application, or even during the operation of a particular instance of the server component.

There are several conventional ways to implement selection algorithms. First, the selection algorithm may be hard-coded into the client/sender component. That is, the selection algorithm may be written as a part of the program code of the client/sender component. Second, the selection algorithm may be offered as a software library component, which may be statically or dynamically linked into the client/sender component. Third, it may be built into the transport service itself For example, the selection algorithm may be provided within the transport service as a generic, parameterized hash algorithm, or a menu of selectable algorithms. Fourth, the selection algorithm may be linked into a separate, intermediate, but still application specific, translation component, which may be upgradable independently from both the client/sender and server/receiver component.

However, each of the conventional approaches may present certain difficulties to a system designer. For example, hard-coding the selection algorithm into the client/sender component is a very rigid approach, and may require a code rewrite and full upgrade of the client/sender component if a change to the selection algorithm is needed. Thus, dynamic updating of the selection algorithm may be difficult or impossible under such a scenario.

Providing the selection algorithm as a library component may make it easier to upgrade the sending component, but may still require a static or dynamic re-linkage, with restart, of the client/sender component.

Building the selection algorithm into the transport service may provide an approach that is independent from both the client/sender component and the server/receiver component, but has two major drawbacks. First, a “one-size-fits-all” approach may not be optimal for either endpoint, since it is unlikely that it can provide exactly the algorithm that is needed. Second, it may be hard to upgrade the selection algorithm in any meaningful way.

Linking the selection algorithm into a separate translation component may provide a more flexible approach, but may incur a heavy penalty on performance, since it may force all messages between the component types in question to pass through one or a few central points. Furthermore, such an algorithm may typically be implemented to execute in user space within a process, which would force an extra context switch between kernel mode and user mode, providing an additional performance penalty.

### SUMMARY

Some embodiments may provide methods of distributing a selection algorithm that selects a target server component from among a plurality of server components having a same functionality type. The methods may include receiving notifications from the plurality of server components indicating addresses at which the plurality of server components can be contacted, receiving a selection algorithm that is to be used by a client component for selecting the target server component from among the plurality of server components, and associating the selection algorithm with the functionality type. The methods may further include receiving a message from the client component requesting addresses of server components having the functionality type, responsive to the functionality type specified in the message from the client component matching the functionality type of the plurality of server components, sending the addresses of the plurality of server components to the client component, and sending the selection algorithm to the client component.

The notifications from the server components may indicate that the plurality of functional components are available, and may indicate the functionality type of the components.

Receiving the selection algorithm may include receiving the selection algorithm from a first one of the server components.

The selection algorithm may include a first selection algorithm, and the methods may further include receiving a second selection algorithm from a second one of the server components after receiving the first selection algorithm from the first one of the server components, and associating the second selection algorithm with the functionality type.

Associating the second selection algorithm with the functionality type may be performed in response to the second selection algorithm having a newer version number and/or date stamp than the first selection algorithm.

Associating the second selection algorithm with the functionality type may be performed in response to the second selection algorithm having a different checksum than the first selection algorithm.

Receiving the selection algorithm may include receiving the selection algorithm from a database that is separate from the plurality of server components.

Receiving the selection algorithm may include receiving a reference to program code that defines the selection algorithm.

Sending the selection algorithm may include sending a reference to program code that defines the selection algorithm.

In some embodiments, receiving the selection algorithm may include receiving program code that defines the selection algorithm, and sending the selection algorithm may include sending a reference to the program code that defines the selection algorithm.

Some embodiments provide methods of selecting a target server component from among a plurality of server components having a same functionality type. The methods include sending a message to a broker component requesting addresses of server components having the functionality type, receiving addresses of the plurality of server components from the broker component, receiving a selection algorithm for selecting the target server component from among the plurality of server components, and executing the selection algorithm to identify the target server component from among the plurality of server components.

Receiving the selection algorithm may include receiving the selection algorithm from the broker component.

Receiving the selection algorithm may include receiving a reference to program code that defines the selection algorithm, the method further including obtaining the program code that defines the selection algorithm using the reference.

Some embodiments provide a system for distributing a selection algorithm that selects a target server component from among a plurality of server components having a same functionality type. The system includes a broker component configured to receive notifications from the plurality of server components indicating addresses at which the plurality of server components can be contacted. The broker component is further configured to receive a selection algorithm that is to be used by a client component for selecting the target server component from among the plurality of server components, configured to associate the selection algorithm with the functionality type, configured to receive a message from the client component requesting addresses of server components having the functionality type, configured to send the addresses of the plurality of server components to the client component responsive to the functionality type specified in the message from the client component matching the functionality type of the plurality of server components, and configured to send the selection algorithm to the client component.

The broker may be configured to receive the selection algorithm from a first one of the server components.

The selection algorithm may include a first selection algorithm, and the broker may be configured to receive a second selection algorithm from a second one of the server components after receiving the first selection algorithm from the first one of the server components, and configured to associate the second selection algorithm with the functionality type.

The broker may be configured to associate the second selection algorithm with the functionality type in response to the second selection algorithm having a newer version number and/or date stamp than the first selection algorithm.

The broker may be configured to associate the second selection algorithm with the functionality type in response to the second selection algorithm having a different checksum than the first selection algorithm

The broker may be configured to receive the selection algorithm from a database that is separate from the plurality of server components.

The broker may be configured to receive a reference to program code that defines the selection algorithm.

The broker may be configured to send a reference to program code that defines the selection algorithm.

In some embodiments, the broker may be configured to receive the selection algorithm as program code that defines the selection algorithm, and the broker may be configured to send a reference to the program code that defines the selection algorithm.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic illustration of systems/methods according to some embodiments.

FIG. 2 is a flow diagram illustrating an example message flow according to some embodiments.

FIGS. 3-9 are flowcharts illustrating operations of systems/methods according to some embodiments.

### DETAILED DESCRIPTION

Embodiments of the present invention are described herein with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Some embodiments of the invention provide systems/methods for dynamically distributing target selection algorithms to software components, such as client/sender components that have a need to identify and obtain an address for a target server/receiver component. These systems/methods may provide a mechanism that allows for in-service upgrading of software processes/services that perform inter-service communication in which a selection algorithm is used to determine which of several instances of a process, such as a server/receiver process, is to be utilized by a client/sender component. For example, a selection algorithm may be used to select a destination address of a particular server/receiver process to which a request is to be sent.

According to some embodiments, a selection algorithm may be distributed along with the destination address substantially concurrently with registration/binding of the server process to the destination address. Likewise, the client/sender component may receive the algorithm when the client/sender performs an address lookup for the destination type of the server process.

The selection algorithm may be distributed in many different forms. For example, the selection algorithm may be distributed as a code sequence, a reference to a code sequence, and/or a set of parameters to be used in a pre-defined selection algorithm that may already be known to the client/sender and/or may be provided to the client sender dynamically. The selection algorithm may be distributed as object code, source code, a set of interpreted commands, or any other form.

As noted above, conventional approaches to providing a selection algorithm may present certain problems to a system designer, because the approaches may be inflexible and/or may incur a performance penalty. Furthermore, the selection algorithm is conventionally defined in and by the client/sender component. However, from the standpoint of system design, it often is the server/receiver component that should more appropriately define the behavior of the selection algorithm.

Furthermore, it may be desirable for the selection algorithm to be easily upgradeable, for example, to meet changing operational environments, system loads, and/or other situations. For example, a service that is being provided by a group of equivalent server/receiver components may be changed to behave differently, such as by having a different redundancy scheme, by having fewer or more numerous server components, by redefining the load balancing scheme, etc. However, it may still be desirable to retain the same functional application programming interface (API) that is presented to the client/sender components. In such a case it may be desirable to update the selection algorithm to be more suitable to the changed conditions without having to upgrade, or even restart, the client/sender components.

Accordingly, embodiments of the present invention may provide a flexible yet efficient method of updating the selection algorithm used by an already running client/sender component, that may cause little or no disturbance at all to the operation of the client/sender component.

According to some embodiments, a selection algorithm may be distributed along with the destination addresses of one or more a server/receiver component when the server/receiver component binds to the address. Likewise, a client/sender may receive the algorithm when the client/sender component does an address lookup for the destination type in question. The selection algorithm may be sent together with the addresses of the server/receiver functional components (i.e. in the same message) and/or may be sent in a separate message from the message in which addresses of the server/receiver functional components are sent.

As noted above, the selection algorithm may be distributed in many different forms, such as a code sequence, a reference to a code sequence, and/or a set of parameters to be used in a pre-defined selection algorithm that may already be known to the client/sender and/or may be provided to the client sender dynamically.

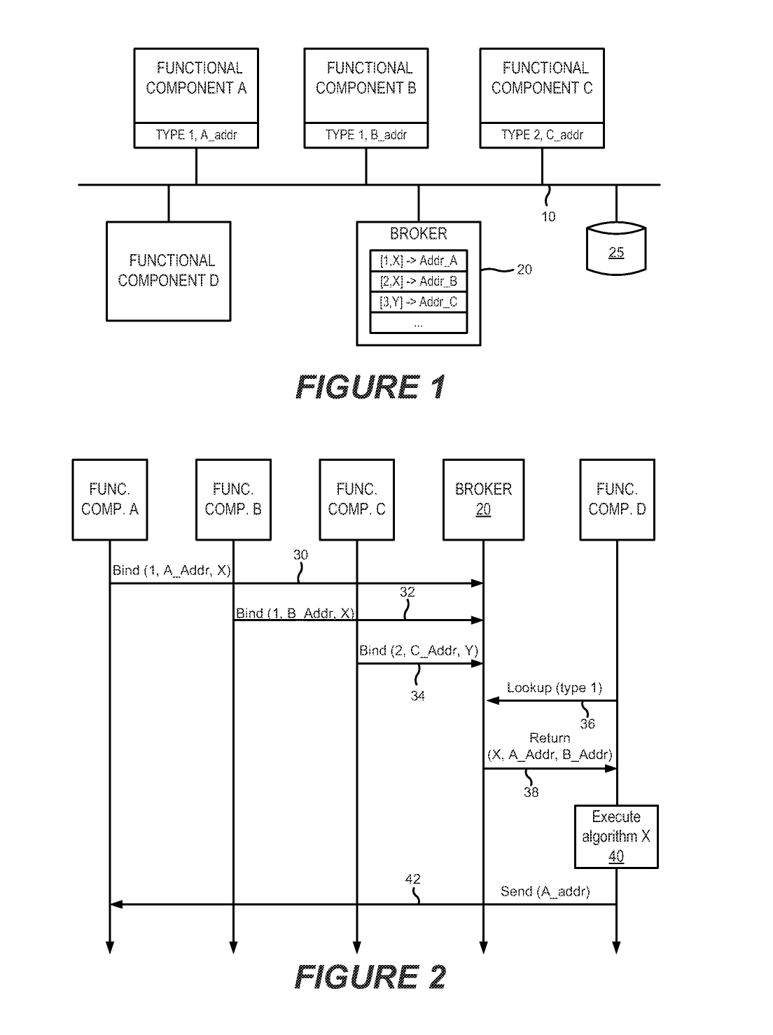

FIG. 1 is a schematic diagram of a system in which systems/methods according to some embodiments may be implemented. Referring to FIG. 1, the system may include a plurality of functional components, denoted Functional Components A, B, C and D, and a name server, or Broker component 20. The functional components may act as client/sender components and/or as server/receiver components, depending on their role in a particular transaction. For example, a particular functional component can act as a client/sender component when it needs to obtain services from another functional component, and as a server/receiver component when another functional component requests services from it.

The functional components A to D and/or the broker 20 can be implemented on the same system in the same or different virtual machines and/or can be implemented on distributed systems. The functional components A to D and/or the broker 20 may be implemented on one or more physical machines, including a general purpose and/or special purpose processor (e.g., a microprocessor and/or a digital signal processor) with on-board and/or separate memory devices. The processor may be configured to execute computer program instructions in functional modules, such as the functional components A to D and/or the broker 20, within a memory to operate as described herein.

The functional components A to D and the broker 20 communicate over a transport system 10 that is arbitrary for purposes of the present invention. The nature of the transport system may be dependent on the nature of the implementation of the functional components. For example, where the functional components and the broker 20 are implemented on a single device, the transport system may include a data bus. In embodiments where the functional components A to D and the broker 20 are implemented on separate virtual or physical machines, the transport system may be a communication network, such as a TCP/IP based communication network.

An algorithm database 25 may be accessible to the broker 20 and/or the functional components A to D in some embodiments. One or more selection algorithms may be stored in the algorithm database 25. Although illustrated as a separate component in FIG. 1, the algorithm database 25 may be implemented in the broker 20 and/or in one or more functional components. The algorithm database 25 can reside in physical or logical memory, in offline or online storage, in a physical or virtual disk drive, and/or in any other conventional locations.

When a server/receiver is created and becomes available to receive client-originated requests, the server/receiver registers itself as available. The name server, or broker, associated with the transport system stores binding information about the server/receiver components that register themselves as available. In the example illustrated in FIG. 1, there are three server/receiver functional components, namely functional components A, B and C. Of these, functional components A and B are indicated as being of functionality type 1, while functional component C represents functionality type 2. In this example, the functionality types are arbitrary. For example, functionality type 1 could represent one particular type of operation performed on an input data set, while functionality type 2 could represent another type of operation performed on an input data set.

By way of example, a server/receiver component having functionality type 1 may encrypt an input data string provided by a client/sender component, while a server/receiver component having functionality type 2 may parse an input string provided by a client/sender component.

In the embodiments illustrated in FIG. 1, there is one client/sender component, denoted functional component D, which desires to obtain the services of a component of type 1. For example, the functional component D may desire to encrypt a string of clear text before sending the string to a third party.

FIG. 2 is a flow diagram illustrating an example operation according to some embodiments. In the example, Component A may register its availability with the broker 20, for example, through a bind call 30 to the broker 20. The bind call 30 may contain information about the type of functionality provided by functional component A (e.g., type 1), the communication address of functional component A at which it can be reached (e.g., address A_addr, which could be an IP address), and the selection algorithm, X, that any client must use to select a destination server/receiver component of functionality type 1, in case there is more than one such component. This information may be stored in a table entry or database record by the broker 20.

Component B, which also performs functionality type 1, also registers its availability with the Broker with a bind call 32, that includes its communication address, B_addr. At this time, functional component B may also provide the selection algorithm X, which the broker 20 may store. In other embodiments, the broker 20 may examine the selection algorithm provided by functional component B, determine if the selection algorithm X has already been provided for components having functionality type 1, and store the new selection algorithm based on one or more predetermined criteria. For example, the broker 20 may store the new selection algorithm if the new selection algorithm is different from the old selection algorithm, if the new selection algorithm has a newer date stamp or version number than the old selection algorithm, if the new selection algorithm has a different checksum than the old selection algorithm, or any other criteria.

Continuing with the example, the third functional component, functional component C, which provides type 2 functionality, registers itself with the broker 20 with a bind call 34. In the bind call 34, functional component C provides its address C_addr, along with a selection algorithm, Y, that is designated for use by a client/sender component wanting services of type 2 functionality components.

In the example, Component D, the client/sender component, has a need to invoke services of a type 1 server/receiver. Accordingly, functional component D needs to know which server/receiver components of type 1 are available. Therefore, functional component D may call the broker 20 with a lookup request 36 that indicates type 1 as the server type it is looking for. The broker responds with one or more return messages 38, indicating that servers of type 1 can be reached at address A_addr and address B_addr, and that the client/sender functional component D should use algorithm X for deciding which of these two available type 1 functional components to utilize for the desired services.

When the client/sender functional component D wants to send a service request to a type 1 server/receiver component, the client/sender functional component D executes the indicated selection algorithm X on some input data (Block 40), so that it can obtain a destination address of a type 1 server/receiver to use. The input data may be any suitable or specified data, such as a phone number or other string, that is specified in the API between client/sender functional component D and server/receiver functional components of type 1. In some embodiments, the input data may be the actual message that is about to be sent. In the latter case, the algorithm itself may decide and/or specify which field or fields of the message will be used as input data, if any. In this example, the selection algorithm may generate the address of functional component A, A_addr, as the address that should be used by the client/sender functional component D for invoking type 1 services.

Finally, client/sender functional component D sends a message 42 to server/receiver functional component A, using address A_addr. The client/sender functional component D may also choose to perform a connect on that address, depending on which type of protocol is used for the message transfer.

The term “selection algorithm” can include a manifestation of an algorithm in the form of a code sequence. It may be written in an interpreted language, such as Java or Perl, but it may even be a sequence of machine instructions, e.g., object code compiled from the C programming language. It will be appreciated that the selection algorithm is not limited to a particular computer programming languages, and that the selection algorithm can be manifested in many different computer programming languages, such as python, Javascript, FORTRAN, php, Haskell, ML and many others.

In some embodiments, distribution of a selection algorithm includes distribution of parameters to be used in a generic parameterized selection algorithm. In such embodiments, the generic parameterized selection algorithm can be installed in and/or otherwise available to each client/sender component, and the broker may provide the appropriate parameters to the client/sender component when the client/sender component issues a lookup request to the broker.

The selection algorithm may take an arbitrary number of input parameters, which may be defined in the API between the client/sender and server/receiver functional components, and may return an arbitrary subset (0, 1, some, or all) of the potential destination addresses as output. It may also modify, or cause modification of, the content of the message that is about to be sent.

The distribution of a selection algorithm to the broker can happen in several different ways. In the binding phase (when a server/receiver declares its availability to the broker), distribution of a selection algorithm may happen when the server/receiver component sends the actual function code to the broker.

In some embodiments, the server/receiver component may only send only a reference to the code, e.g., a file system path and/or uniform resource indicator (URI), to the broker.

In some embodiments, the server may not send either program code or a reference to program code to the broker. Since the relation between functional component type and selection algorithm may be one-to-one (i.e., there may only be one designated selection algorithm for each functionality type), it may be possible in some embodiments for the broker to locate the proper algorithm based on the function component type. For example, selection algorithms may be associated with particular functional component types, and the association may be stored in a database that is accessible by the broker, such as the algorithm database 25 shown in FIG. 1.

During the lookup phase (i.e., when a client/sender queries the broker to find an address of a server/receiver of a desired functionality type), the broker may send the actual code to the client. In some embodiments, the broker may only send a reference to the code, e.g., a file system path or URI, to the client. Moreover, it may be possible in some embodiments for the client/sender to locate the proper algorithm based on the function component type only. For example, selection algorithms may be associated with particular functional component types, and the association may be stored in a database that is accessible by the client/sender, such as the algorithm database 25 shown in FIG. 1.

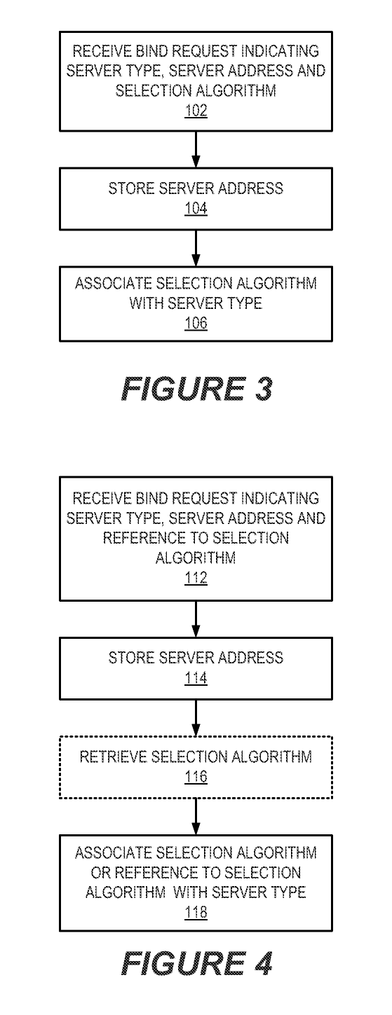

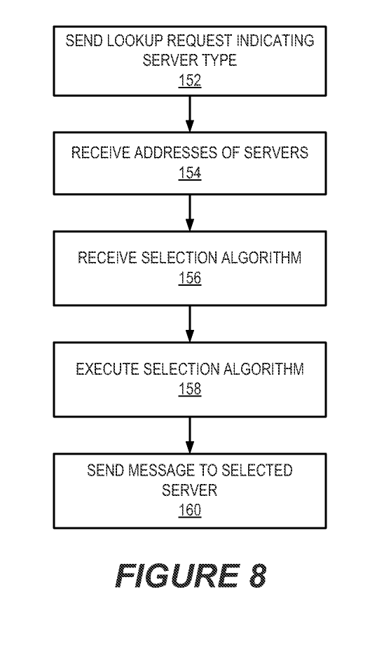

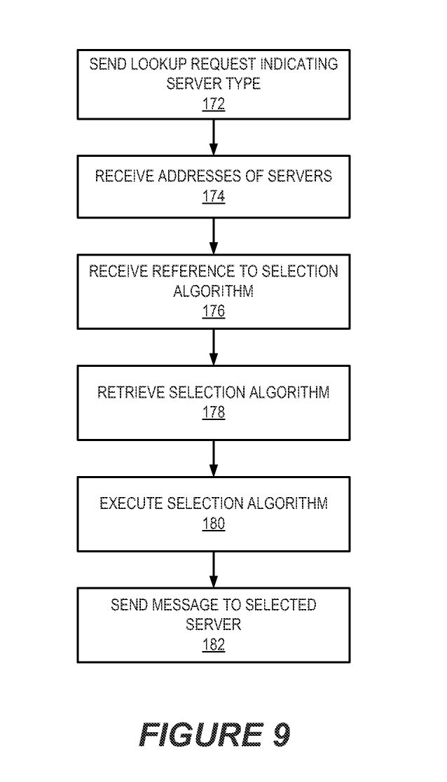

FIGS. 3-9 are flowcharts illustrating operations of systems/methods according to some embodiments. In particular, FIGS. 3-7 illustrate operations of a broker component according to some embodiments, while FIGS. 8-9 illustrate operations of a client component according to some embodiments.

Referring to FIG. 3, a broker component, such as the broker 20 illustrated in FIGS. 1 and 2, receives a bind request indicating the server type associated with the bind request, the server address, and the selection algorithm that is to be used for selecting from among servers of the specified type (Block 102). The broker 20 may store the server address (Block 104) and associate the selection algorithm with the server type, for example, by generating a database record (Block 106).

Referring to FIG. 4, in some embodiments, a broker 20 receives a bind request indicating the server type associated with the bind request, the server address and a reference to the selection algorithm that is to be used for selecting from among servers of the specified type (Block 112). The broker 20 may store the server address (Block 114). The broker 20 may optionally retrieve the selection algorithm based on the reference to the selection algorithm (Block 116). The broker 20 may associate the selection algorithm or the reference to the selection algorithm with the server type (Block 118).

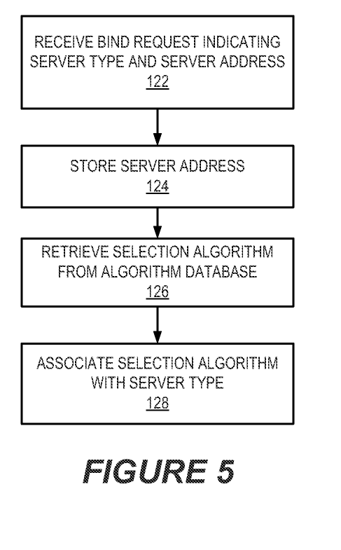

Referring to FIG. 5, the broker 20 may receive a bind request indicating the server type and the server address (Block 122). The broker 20 may store the server address (Block 124), and may retrieve the selection algorithm, for example, from an algorithm database 25 as illustrated in FIG. 1. (Block 126). The broker may associate the selection algorithm with the indicated server type (Block 128).

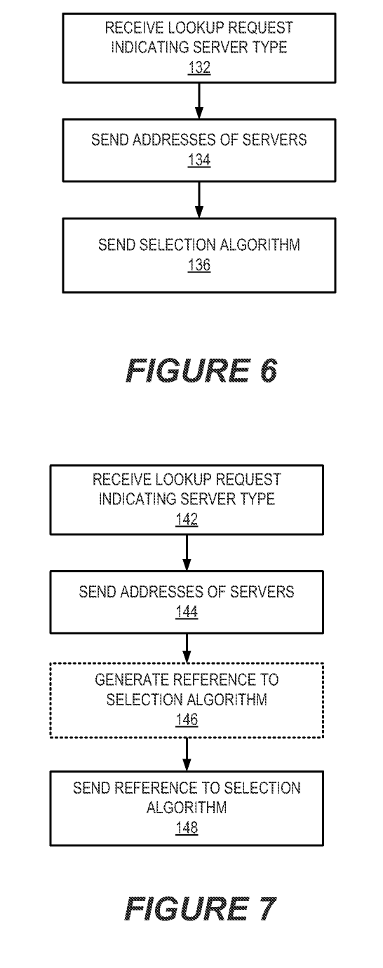

Referring to FIG. 6, a broker 20 may receive a message, such as a lookup request, from a client functional component indicating the functionality type of server that the functional component is looking up (Block 132). In response, the broker 20 may send the addresses of one or more servers of the specified functionality type (Block 134). The broker 20 may also send the selection algorithm that is to be used by the client functional component in selecting from among available servers (Block 136).

Referring to FIG. 7, in some embodiments, a broker 20 may receive a message, such as a lookup request, from a functional component indicating the functionality type of server that the functional component is looking up (Block 142). In response, the broker 20 may send the addresses of one or more servers of the specified functionality type (Block 144). The broker 20 may optionally generate a reference to the selection algorithm for the specified functionality type (Block 146), and then send the reference to the selection algorithm to the functional component (Block 148). For example, in some embodiments, the broker 20 may have received the selection algorithm or a reference to the selection algorithm, and the broker may send a reference to the selection algorithm to the client functional component. In cases where the broker 20 has received the selection algorithm, either from a server functional component or from an algorithm database, the broker 20 may generate a reference to the selection algorithm and send only the reference to the client functional component. Such an approach may reduce communication requirements for the broker 20, which may not have to send the selection algorithm every time a lookup request is received.

Furthermore, a number of candidate selection algorithms could reside at the client functional component, and the response from the broker 20 to the lookup request may identify which of the selection algorithms to use. In other embodiments, the broker 20 may provide parameters to the client functional component to be used in executing a generic parameterized selection algorithm that is stored in or otherwise available to the client functional component.

Referring to FIG. 8, operations of a client functional component according to some embodiments are illustrated. In particular, a client functional component may send a request, such as a lookup request, to a broker (Block 152). The lookup request may specify the type of server that the client functional component needs to contact. In response to the lookup request, the client functional component receives addresses of one or more servers of the specified type (Block 154). The client functional component may also receive the selection algorithm (Block 156). The selection algorithm may include program code for the algorithm and/or parameters to be used in a generic selection algorithm.

The client functional component may then execute the specified selection algorithm to determine which address it should use (Block 158). Once the address has been selected, the client functional component may send a message to the selected server (Block 160).

FIG. 9 illustrates operations of a client functional component according to further embodiments. As shown therein, a client functional component may send a request, such as a lookup request, to a broker (Block 172). The lookup request may specify the type of server that the client functional component needs to contact. In response to the lookup request, the client functional component receives addresses of one or more servers of the specified type (Block 174). The client functional component may also receive a reference to the selection algorithm (Block 176).

The client functional component may then retrieve the selection algorithm based on the provided reference (Block 178), and execute the specified selection algorithm to determine which address it should use (Block 180). Once the address has been selected, the client functional component may send a message to the selected server (Block 182).

If the selection algorithm is changed or replaced, all current clients using it may need to be updated to use the new or updated selection algorithm. This may happen in a reactive way, i.e., send requests from client/senders may rejected, triggering a new lookup that results in distribution of the updated selection algorithm to the client/sender.

In other embodiments, updating of the selection algorithm to existing client/sender components may also be done by letting each lookup received from a client/sender component act as a subscription to updates from the broker, so that the change, or a notification about the change, is pushed from the broker out to each client/sender. To implement this, it may be desirable for the broker to maintain a record of the identity and address of each client/sender that sends a lookup request to the broker.

If a server/receiver component is added or removed, it may be desirable to notify all client/servers about the change. This may also happen reactively, or as a result of a subscription, just as in the case with algorithm change.

Embodiments of the present invention may provide significant flexibility in the operation of a system that includes inter-communicating functional components. For example, some embodiments enable a system to dynamically add or remove functional component selection algorithms in a running system. Some embodiments also may enable the use of tailor-made algorithms for particular types of functionality or client-server relationships.

As will be appreciated by one of skill in the art, the present invention may be embodied as a method, a system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

Some embodiments of the present invention are described herein with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java or C++. However, the computer program code for carrying out operations of the present invention may also be written in conventional procedural programming languages, such as the “C” programming language. The program code may execute entirely on the user's computer, partly on the user's computer, as a stand alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of distributing a selection algorithm that selects a target server component from among a plurality of server components having a same functionality type, the method comprising:
receiving notifications from the plurality of server components indicating addresses at which the plurality of server components can be contacted;
receiving a selection algorithm that is to be used by a client component for selecting the target server component from among the plurality of server components having the same functionality type;
associating the selection algorithm with the functionality type;
receiving a message from the client component requesting addresses of server components having the functionality type;
responsive to the functionality type specified in the message from the client component matching the functionality type of the plurality of server components, sending the addresses of the plurality of server components to the client component; and
sending the selection algorithm to the client component.

2. The method of claim 1, wherein the notifications from the server components indicate that the plurality of functional components are available, and indicate the functionality type of the components.

3. The method of claim 1, wherein receiving the selection algorithm comprises receiving the selection algorithm from a first one of the server components.

4. The method of claim 3, wherein the selection algorithm comprises a first selection algorithm, the method further comprising receiving a second selection algorithm from a second one of the server components after receiving the first selection algorithm from the first one of the server components, and associating the second selection algorithm with the functionality type.

5. The method of claim 4, wherein associating the second selection algorithm with the functionality type is performed in response to the second selection algorithm having a newer version number and/or date stamp than the first selection algorithm.

6. The method of claim 4, wherein associating the second selection algorithm with the functionality type is performed in response to the second selection algorithm having a different checksum than the first selection algorithm

7. The method of claim 1, wherein receiving the selection algorithm comprises receiving the selection algorithm from a database that is separate from the plurality of server components.

8. The method of claim 1, wherein receiving the selection algorithm comprises receiving a reference to program code that defines the selection algorithm.

9. The method of claim 1, wherein sending the selection algorithm comprises sending a reference to program code that defines the selection algorithm.

10. The method of claim 1, wherein receiving the selection algorithm comprises receiving program code that defines the selection algorithm, and wherein sending the selection algorithm comprises sending a reference to the program code that defines the selection algorithm.

11. A method of selecting a target server component from among a plurality of server components having a same functionality type, the method comprising:
sending a message to a broker component requesting addresses of server components having the functionality type;
receiving addresses of the plurality of server components from the broker component;
receiving a selection algorithm for selecting the target server component from among the plurality of server components; and
executing the selection algorithm to identify the target server component from among the plurality of server components.

12. The method of claim 11, wherein receiving the selection algorithm comprises receiving the selection algorithm from the broker component.

13. The method of claim 11, wherein receiving the selection algorithm comprises receiving a reference to program code that defines the selection algorithm, the method further comprising obtaining the program code that defines the selection algorithm using the reference.

14. A system for distributing a selection algorithm that selects a target server component from among a plurality of server components having a same functionality type, the system comprising:
a broker component configured to receive notifications from the plurality of server components indicating addresses at which the plurality of server components can be contacted;
wherein the broker component is further configured to receive a selection algorithm that is to be used by a client component for selecting the target server component from among the plurality of server components, configured to associate the selection algorithm with the functionality type, configured to receive a message from the client component requesting addresses of server components having the functionality type, configured to send the addresses of the plurality of server components to the client component responsive to the functionality type specified in the message from the client component matching the functionality type of the plurality of server components, and configured to send the selection algorithm to the client component.

15. The system of claim 14, wherein the broker is configured to receive the selection algorithm from a first one of the server components.

16. The system of claim 15, wherein the selection algorithm comprises a first selection algorithm, wherein the broker is configured to receive a second selection algorithm from a second one of the server components after receiving the first selection algorithm from the first one of the server components, and configured to associate the second selection algorithm with the functionality type.

17. The system of claim 16, wherein the broker is configured to associate the second selection algorithm with the functionality type in response to the second selection algorithm having a newer version number and/or date stamp than the first selection algorithm.

18. The system of claim 16, wherein the broker is configured to associate the second selection algorithm with the functionality type in response to the second selection algorithm having a different checksum than the first selection algorithm

19. The system of claim 14, wherein the broker is configured to receive the selection algorithm from a database that is separate from the plurality of server components.

20. The system of claim 14, wherein the broker is configured to receive a reference to program code that defines the selection algorithm.

21. The system of claim 14, wherein the broker is configured to send a reference to program code that defines the selection algorithm.

22. The system of claim 14, wherein the broker is configured to receive the selection algorithm as program code that defines the selection algorithm, and wherein the broker is configured to send a reference to the program code that defines the selection algorithm.
